(19) United States
(12) Patent Application Publication
(10) Pub. No.: US 2016/0260964 A1
(43) Pub. Date: Sep. 8, 2016

(54) LITHIUM ION BATTERY CATHODE MATERIAL

(71) Applicant: Colorado School of Mines, Golden, CO (US)

(72) Inventors: Yongan Yang, Lakewood, CO (US); Tara S. Yoder, Golden, CO (US)

(21) Appl. No.: 14/487,710

(22) Filed: Sep. 16, 2014

Related U.S. Application Data
(60) Provisional application No. 61/878,441, filed on Sep. 16, 2013.

(51) Int. Cl. H01M 4/133; H01M 10/0525; H01M 4/1397; H01M 4/136; H01M 4/04; H01M 4/1393

(52) U.S. Cl. CPC H01M 4/133; H01M 4/0402; H01M 4/049; H01M 4/1393; H01M 4/1397; H01M 4/136; H01M 10/0525; H01M 2004/028

(57) ABSTRACT

The present disclosure generally relates to lithium ion battery cathode materials, and methods of making and using the same.

This application claims priority to U.S. provisional application No. 61/878,441, filed on Sep. 16, 2013, and entitled “Lithium Ion Battery Cathode Material,” the entirety of which is hereby incorporated by reference for all purposes.

### TECHNICAL FIELD

The present disclosure relates to lithium ion battery cathode materials, and methods of making and using the same.

### BACKGROUND

The lack of low-cost, high-performance rechargeable batteries is a sizable hurdle for further upgrading portable electronic devices and (hybrid) electric vehicles. One reason has been poorly performing cathode materials. Iron pyrite (p-FeS₂) has been used in cathodes of both rechargeable lithium ion batteries (LIBs) at high temperatures and non-rechargeable LIBs at room temperatures. However, developing p-FeS₂-based rechargeable, room temperature LIBs has been unsuccessful at least in part because the cyclability of the p-FeS₂ cathode material has been limited. Thus, a p-FeS₂ cathode material for rechargeable, room temperature LIBs with higher cyclability is needed.

The information included in this Background section of the specification is included for technical reference purposes only and is not to be regarded as subject matter by which the scope of the claims is to be bound.

### SUMMARY

The present disclosure is directed to a lithium ion battery cathode material. In one embodiment, the lithium ion battery cathode material includes a plurality of carbon nanostructures and iron pyrite. The nanostructures may be nanotubes. At least a subgroup of the nanostructures may encapsulate the iron pyrite. The subgroup may be configured to protect the iron pyrite from an electrolyte. The diameter of the nanostructures of the subgroup may be 25-250 nm or 50-200 nm. The nanostructures and subgroup may be configured to form an electrical network. The capacity fading rate of the subgroup may be less than 0.05% per cycle, and the retention ratio may be greater than 67% after 100 cycles of discharging and charging.

The present disclosure is also directed to a method of making carbon-nanostructure-encapsulated iron pyrite. In one embodiment, the method includes producing iron pyrite inside anodic aluminum oxide-encapsulated carbon nanostructures by soaking the nanostructures in a solution of Fe(S₂CNEt₂)₃ and dissolving the anodic aluminum oxide. Soaking the nanostructures before dissolving the aluminum oxide may produce iron pyrite only on the inside of the nanostructures, which can protect the iron pyrite from an electrolyte. The encapsulated iron pyrite produced by the method may be collected. The anodic aluminum oxide may be a template for the nanostructures. The Fe(S₂CNEt₂)₃ may be solvothermally decomposed to produce the iron pyrite. The carbon nanostructures may be nanotubes.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present disclosure as defined in the claims is provided in the following written description of various embodiments and illustrated in the accompanying drawings.

### BRIEF DESCRIPTION OF THE DRAWINGS

FIG. 1 is a schematic diagram of one embodiment of a cathode comprising p-FeS₂@CNTs and CNTs.

FIG. 2 is a schematic diagram of one embodiment of the synthesis of p-FeS₂@CNTs.

FIG. 3A depicts TEM images of reference CNTs.

FIG. 3B depicts TEM images of reference S@CNTs

FIG. 3C depicts TEM images of CNTs synthesized according to the procedure of Example 1.

FIG. 3D depicts XRD and TEM images of phase-pure p-FeS₂ nanopowders.

FIG. 4A is a schematic diagram of p-FeS₂@CNTs.

FIG. 4B is a schematic diagram of p-FeS₂+CNTs.

FIG. 4C is a schematic diagram of p-FeS₂.

FIG. 5 depicts discharging capacity for p-FeS₂@CNTs+CNTs versus the number of cycles. The inset is a two-electrode split-flat cell.

FIG. 6 depicts Raman spectra of p-FeS₂ nanoparticles, reference Li₂FeS₂, reference Li₂S, and S.

### DETAILED DESCRIPTION

The present disclosure provides lithium ion battery cathode materials and methods of making the same. The cathode materials comprise a plurality of carbon nanostructures and iron pyrite (p-FeS₂). In certain aspects, at least a subgroup of the carbon nanostructures encapsulate the p-FeS₂. In various aspects, encapsulating the p-FeS₂inside a carbon nanostructure can help protect the p-FeS₂ from exposure to an electrolyte, which can improve the cyclability of the cathode material compared to a conventional unprotected p-FeS₂ cathode material.

The presently disclosed cathode materials can be low in cost with reduced environmental impact. For example, p-FeS₂ is the most abundant sulfide mineral on the earth and is therefore inexpensive. In addition, both Fe and S are non-toxic.

Iron Pyrite

The cathode material comprises iron pyrite (p-FeS₂). Cathode materials comprised of iron pyrite store lithium ions by a conversion mechanism in which original lattices are broken to form alloys. Cathode materials that store lithium ions by a conversion mechanism can have greater charge capacities than cathode materials that store lithium ions by an intercalation mechanism in which lithium atoms are inserted into the void space without breaking the host crystal structures.

A p-FeS₂ cathode material can have a large theoretical charge capacity. p-FeS₂ has a theoretical charge capacity of approximately 890 mA·h/g, which is approximately 3 times larger than the charge capacity of CoO₂. p-FeS₂ also has a specific energy density of approximately 1335 mW·h/g, which is approximately 1.5 times higher than the specific energy density of CoO₂.

A cathode material can be characterized by its cyclability, which is the reversibility of the charging and discharging reactions. Cathode materials can have good cyclability if the reactions are largely reversible. Cathode materials can have poor cyclability if the reactions are largely irreversible.

The poor cyclability of traditional p-FeS₂ cathodes can be attributed to the poor electrical conductivity of the discharging product of Li₂S, the irreversible chemical reactions between p-FeS₂ and the electrolyte, the loss of materials due to the formation of polysulfides, and/or the loss of the electrical contact between p-FeS₂ and the current collector due to p-FeS₂ volume fluctuation during the discharging/charging cycles.

The discharging/charging cycles of p-FeS₂ can be described in terms of at least four reactions. During the first discharging process, p-FeS₂ accommodates 4Li⁺ and 4e⁻ and then converts to Fe+Li₂S, according to reactions (1) and (2):

FeS₂+2Li⁺+2e⁻→Li₂FeS₂ (1)

Li₂FeS₂+Li⁺+2e⁻→Fe⁰+2Li₂S (2)

Both reactions occur at approximately 1.5V. At lower temperatures (e.g. 20-200 ° C.), reaction (1) is irreversible and reaction (2) has limited reversibility.

During the subsequent charging process, reaction (2) is reversed (i.e., reaction (3)) at approximately 1.5 V and the product Li₂FeS₂ is further oxidized to Li₂₋ₓFeS₂ by releasing ≦0.8 Li⁺ (reaction (4)) at approximately 2.0V:

Fe⁰⁺2Li₂S→Li₂FeS₂+2Li⁺+2e⁻ (3)

Li₂FeS₂→Li₂₋ₓFeS₂+xLi⁺+xe⁻⁽0<×≦0.8) (4)

In the subsequent discharging processes, reactions (3) and (4) are reversed at approximately 1.7V and approximately 2.0V, respectively.

The formation of lithium polysulfides (Li₂Sₙ, n≧2) can cause the loss of cathode materials and the concomitant decrease in the cyclability of FeS₂ cathodes. Lithium polysulfides can form on the cathode surface. The lithium polysulfides have poor conductivity and are inactive in subsequent re-charging processes. These polysulfides can impede the deep diffusion of lithium ions into the electrode body.

The addition of a polar solvent, such as 1,3-dioxolane, can dissolve Li₂Sₙ. Dissolving Li₂Sₙ can help alleviate the loss of cathode materials. Dissolved Li₂Sₙ can also react with a lithium anode to form lower-order polysulfides (Li₂Sₙ₋ₓ) and then diffuse back to the cathode to form higher order polysulfides (Sₘ²), which can cause a detrimental “shuttle reaction” as described in Peled et al. (Elecrochimica Acta (1998) 43:1593-1599). The presently disclosed lithium ion battery cathodes can help reduce the loss of cathode materials and the related shuttle mechanism problem.

A current collector can lose electrical contact with p-FeS₂. The loss of contact can be caused by volume fluctuation during the discharging/charging cycles. The volume can expand by approximately 260% during the discharging process. The volume can contract during the charging process. During the contraction, p-FeS₂ can lose electrical contact with an electrode. The presently disclosed lithium ion battery cathodes can help reduce the loss of electrical contact due to volume fluctuation.

Carbon Nanostructures

The cathode material can comprise carbon nanostructures, such as carbon nanotubes (CNTs). The carbon nanostructures are chemically inert, electrically conductive, and/or mechanically robust.

CNTs can have one or more different diameters. For example, CNTs with a diameter of 2-10 nm are commercially available (Sigma Aldrich, St. Louis, Mo.). CNTs can be synthesized at any diameter according to the procedure of Example 1. In one embodiment, the synthesized CNTs are 25-250 nm in diameter. In another embodiment, CNTs are 50-200 nm in diameter.

In one embodiment, CNTs are greater than 25 nm in diameter. In another embodiment, CNTs are greater than 50 nm in diameter. In another embodiment, CNTs are greater than 75 nm in diameter. In yet another embodiment, CNTs are greater than 100 nm in diameter. In still another embodiment, CNTs are greater than 150 nm in diameter. In another embodiment, CNTs are less than 250 nm in diameter. In another embodiment, CNTs are less than 200 nm in diameter. In another embodiment, CNTs are less than 150 nm in diameter. In yet another embodiment, CNTs are less than 100 nm in diameter. In still another embodiment, CNTs are less than 50 nm in diameter.

CNTs can be single-walled or multi-walled. CNTs can have any wall thickness. In one embodiment, CNTs have a wall thickness of 1-30 nm. In another embodiment, CNTs have a wall thickness of 5-20 nm. In another embodiment, CNTs have a wall thickness greater than 1 nm. In another embodiment, CNTs have a wall thickness greater than 5 nm. In another embodiment, CNTs have a wall thickness greater than 10 nm. In yet another embodiment, CNTs have a wall thickness greater than 15 nm. In another embodiment, CNTs have a wall thickness less than 30 nm. In another embodiment, CNTs have a wall thickness less than 25 nm. In another embodiment, CNTs have a wall thickness less than 20 nm. In yet another embodiment, CNTs have a wall thickness less than 15 nm. In yet another embodiment, CNTs have a wall thickness less than 10 nm.

CNTs can have one or more different lengths. In one embodiment, CNTs have a length of 1-5 μm. In one embodiment, CNTs are greater than 1 μm in length. In another embodiment, CNTs are greater than 2 μm in length. In another embodiment, CNTs are greater than 3 μm in length. In another embodiment, CNTs are less than 5 μm in length. In another embodiment, CNTs are less than 4 μm in length. In another embodiment, CNTs are less than 3 μm in length.

CNTs can be highly conductive for electrons, highly permeable for lithium ions, highly resistant to most chemicals, and/or highly tolerant of volume fluctuation. CNTs can accommodate volume expansion.

Carbon Nanostructures that Encapsulate FeS₂

In some embodiments, the carbon nanostructures described above can encapsulate p-FeS₂. For example, carbon nanotubes can encapsulate iron pyrite (p-FeS₂@CNTs).

CNTs can completely or partially encapsulate p-FeS₂. The p-FeS₂ of p-FeS₂@CNTs can be synthesized only inside the CNTs and not on the outside surface. This localization protects some or all of the p-FeS₂ from an electrolyte solution because some or all of the encapsulated p-FeS₂ is not exposed directly to the electrolyte solution. p-FeS₂ that is exposed directly to electrolyte solution can be limited to p-FeS₂ at or near the ends of the CNTs. Localization of p-FeS₂ only inside the CNTs can avoid the loss of p-FeS₂, which is a known deficiency of previous carbon nanotube cathode materials and of porous carbon with open voids.

Protecting p-FeS₂ from an electrolyte solution can also help prevent irreversible chemical reactions between p-FeS₂ and electrolyte. Protecting p-FeS₂ from an electrolyte solution can help prevent the dissolution of polysulfides and the subsequent shuttle mechanism. Compared to exposing p-FeS₂ to an electrolyte, protecting p-FeS₂ from an electrolyte can help increase the effective amount of the p-FeS₂ active materials, which in turn can increase capacity and reversibility with the charging/discharging cycles. For example, protecting p-FeS₂ from an electrolyte can help improve the reversibility between Li₂₋ₓFeS₂ and Fe+Li₂S (see reactions (3) and (4) above).

p-FeS₂@CNTs can be highly conductive for electrons. p-FeS₂@CNTs can be highly permeable for lithium ions. p-FeS₂@CNTs can enhance the electron flow to p-FeS₂ and the subsequently generated Fe+Li₂S. p-FeS₂@CNTs can be highly resistant to most chemicals. p-FeS₂@CNTs can be highly tolerant of volume fluctuation.

Without being limited to any mechanism or mode of action, p-FeS₂@CNTs can help mitigate one or more of the factors that contribute to the poor cyclability of p-FeS₂. For example, p-FeS₂@CNTs can mitigate the poor electrical conductivity of the discharging product of Li₂S by protecting p-FeS₂from an electrolyte. As another example, p-FeS₂@CNTs can mitigate the irreversible chemical reactions between p-FeS₂ and the electrolyte by protecting p-FeS₂from an electrolyte. p-FeS₂@CNTs can also reduce the loss of materials due to the formation of polysulfides by protecting p-FeS₂from an electrolyte. As a further example, p-FeS₂@CNTs can reduce the loss of the electrical contact between p-FeS₂ and the current collector due to volume fluctuation during the discharging/charging cycles by protecting p-FeS₂ from an electrolyte and/or by forming or maintaining an electrical network within a cathode material.

Composite Cathode Materials

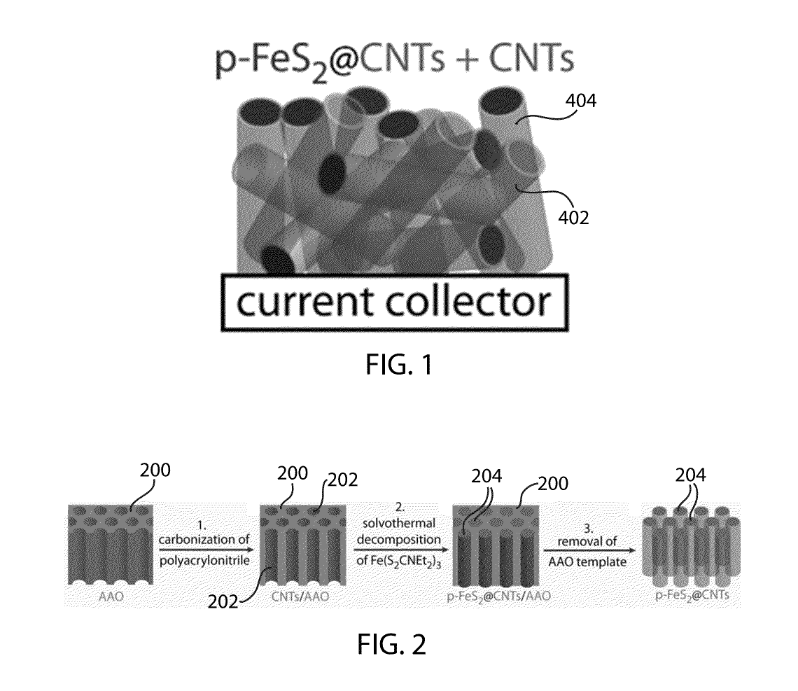

In some implementations, a cathode material comprises one cathode material described above. For example, FIG. 4C is a schematic diagram of a cathode material comprised of p-FeS₂400 alone. In some implementations, a cathode material comprises more than one cathode material described above. Exemplary composite cathode materials comprised of more than one cathode material include p-FeS₂+CNTs, p-FeS₂@CNTs, and p-FeS₂@CNTs+CNTs. For example, FIG. 4B is a schematic diagram of a cathode material comprised of p-FeS₂400+CNTs 402, and FIG. 4A is a schematic diagram of a composite cathode material comprised of p-FeS₂@CNTs 404. As another example, FIG. 1 is a schematic diagram of a cathode material comprised of p-FeS₂@CNTs 404+CNTs 402.

CNTs can help cathode materials form electrical networks. For example, CNTs can help p-FeS₂@CNTs form electrical networks by creating and maintaining electrical contact with each other and/or with a current collector during a re-charging process. Without being limited to any mechanism or mode of action, CNTs physically connect p-FeS₂@CNTs to each other and/or to the current collector and maintain these physical connections even during and following the large volume expansion that occurs after a discharging process.

CNTs filled with electrolyte can provide and/or accommodate Li⁺ ions. For example, CNTs filled with electrolyte can store lithium ions extracted out of LiₓFeS₂. CNTs filled with electrolyte can provide lithium ions to FeS₂ during the lithiation process. CNTs filled with electrolyte can help increase the rate capability (the speed of charging/discharging) of p-FeS₂ or of p-FeS₂@CNTs. Without being limited to any mechanism or mode of action, CNTs bridge FeS₂@CNTs to form interconnected networks, which decreases the lithium diffusion length and the electron diffusion length compared to the absence of CNTs. The decreased diffusion length in turn helps to increase the lithiation/delithiation rate.

In some comparisons of the cyclability performance of cathode materials, the cyclability performance of p-FeS₂@CNTs+CNTs can be greater than the cyclability performance of p-FeS₂@CNTs. The cyclability performance of p-FeS₂@CNTs can be greater than the cyclability performance of p-FeS₂+CNTs. The cyclability performance of p-FeS₂+CNTs can be greater than the cyclability performance of p-FeS₂. The cyclability performance of p-FeS₂ alone is poor.

Without being limited to any mechanism or mode of action, p-FeS₂@CNTs+CNTs can help mitigate one or more of the factors that contribute to the poor cyclability of p-FeS₂. For example, p-FeS₂@CNTs+CNTs can mitigate the poor electrical conductivity of the discharging product of Li₂S by protecting p-FeS₂ from an electrolyte. As another example, p-FeS₂@CNTs can mitigate the irreversible chemical reactions between p-FeS₂ and the electrolyte by protecting p-FeS₂ from an electrolyte. p-FeS₂@CNTs+CNTs can also reduce the loss of materials due to the formation of polysulfides by protecting p-FeS₂from an electrolyte. As a further example, p-FeS₂@CNTs+CNTs can reduce the loss of the electrical contact between p-FeS₂ and the current collector due to volume fluctuation during the discharging/charging cycles by protecting p-FeS₂ from an electrolyte and/or by forming or maintaining an electrical network within a cathode material

The ability of p-FeS₂@CNTs+CNTs to reduce one or more of the above factors that contribute to the poor cyclability can be adjusted by tuning the diameter of the CNTs and/or the CNTs in p-FeS₂@CNTs. The ability of p-FeS₂@CNTs+CNTs to reduce one or more of the above factors that contribute to the poor cyclability can be adjusted by tuning the wall thickness of the CNTs and/or the CNTs in p-FeS₂@CNTs.

Properties of Cathodes

A cathode comprised of p-FeS₂@CNTs+CNTs composite cathode material can have improved performance over a cathode comprised of p-FeS₂ cathode material. For example, a cathode comprised of p-FeS₂@CNTs+CNTs composite cathode material has a faster cyclability than a cathode comprised of p-FeS₂ cathode material. The capacity of a cathode comprised of p-FeS₂@CNTs+CNTs composite cathode material during the initial discharging process can be approximately 890 mA·h/g. The second discharging cycle can be approximately 620 mA·h/g, which can correspond to an injection of 2.8Li⁺ per Fe into Li_{1.2}FeS₂, which can be formed after the first charging process. Subsequently, a capacity-fading rate can be <0.05% per cycle, and a retention ratio can be >67% after 100 cycles (590 mA·h/g). By comparison, a LiₓFeS₂ electrode has a 64% retention ratio after 15 cycles.

As another example, a cathode comprised of p-FeS₂@CNTs+CNTs composite cathode material has a higher rate capability than a cathode comprised of p-FeS₂ cathode material. At a given cycling rate (such as 0.1 C, 0.5 C, 1 C, or 2 C), the capacity and retention ratio of a cathode comprised of p-FeS₂@CNTs+CNTs composite cathode material will be higher than that of a cathode comprised of p-FeS₂ cathode material.

As another example, a cathode comprised of p-FeS₂@CNTs+CNTs composite cathode material has a higher Coulombic efficiency (η, η=C_{-Li}/C_{+Li}, where C_{-Li} and C_{+Li} refer to the capacity during Li extraction and insertion, respectively) compared to a cathode comprised of p-FeS₂ cathode material.

As yet another example, a cathode comprised of p-FeS₂@CNTs+CNTs composite cathode material has a higher thermodynamic reversibility than a cathode comprised of p-FeS₂ cathode material. The Gibbs free energy (ΔG) of the cycling reaction of a cathode comprised of p-FeS₂@CNTs+CNTs composite cathode material is smaller than of a cathode comprised of p-FeS₂ cathode material. A smaller ΔG correspond to a smaller difference between the delithiation voltage and the lithiation voltage.

### EXAMPLES

The following examples illustrate various aspects of the disclosure, and should not be considered limiting.

### Example 1

### In Situ Encapsulation of p-FeS₂ by CNTs

Iron pyrite is encapsulated into a template of CNTs by a solvothermal synthesis process adopted from Guo et al. ((Nano Letters (2011) 11:4288-4294)). With reference to FIG. 2, a piece of anodic aluminum oxide (AAO) membrane 200 (Whatman, GE Healthcare Life Sciences, Piscataway, N.J.; Synkera Technologies, Longmont, Colo.) is filled with a 2,5-dimethylfuran (DMF) solution of polyacrylonitrile (PAN). Then DMF is removed at 150 ° C. in a vacuum oven. Next, the PAN-wetted AAO membrane 200 is heated at 250 ° C. in air for 30 minutes to stabilize PAN, and at 600 ° C. in N₂ for 1 hour to carbonize PAN, which produces CNTs 202 inside the AAO membrane 200.

Next, the AAO membrane 200 with CNTs 202 is soaked in a DMF solution of Fe(S₂CNEt₂)₃ for 2 hours in an autoclave bomb. Then the whole system is maintained at 200° C. for 18 hours. The solvothermal decomposition of Fe(S₂CNEt₂)₃ yields p-FeS₂ encapsulated by CNTs (“p-FeS₂@CNTs” 204).

The AAO membrane 200 template is dissolved with a 1M NaOH etching solution. Then p-FeS₂@CNTs 204 are collected through centrifugation. The pore diameters of the AAO membranes 200, and thus the resulting diameters of CNTs 202 and then p-FeS₂@CNTs 204, are 200 nm, 100 nm, and 50 nm. The wall thickness (5-20 nm) of the CNTs 202 and then p-FeS₂@CNTs 204 is controlled by tuning the PAN concentration and/or repeating the wetting/carbonization processes.

Compared to the method of Guo et al., the synthesis of p-FeS₂ is conducted before, not after, dissolving the AAO template. p-FeS₂ is thus synthesized only inside the CNTs and not on the outside surfaces. This modification protects p-FeS₂ from an electrolyte solution because encapsulated p-FeS₂ is not exposed directly to the electrolyte solution. Such a modification avoids the loss of p-FeS₂, which is a known deficiency of existing methods.

### Example 2

### TEM Images

CNTs were synthesized according to the procedure in Example 1. Phase-pure p-FeS₂ nanopowders were synthesized using water or toluene as a solvent instead of DMF. Water and toluene are alternative solvents if DMF cannot wet the CNTs effectively. The CNTs and p-FeS₂ nanopowders were tested using TEM and XRD and were compared to reference CNTs.

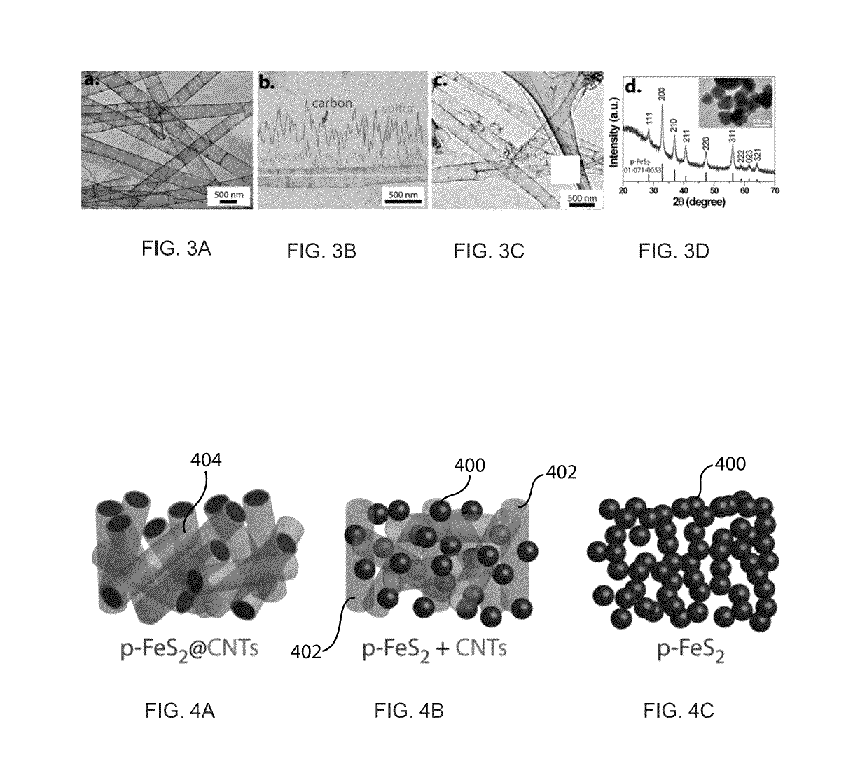

CNTs and S @CNTs (sulfur encapsulated by CNTs) from Guo et al. (supra) and Chen et al. (Advanced Functional Materials (2006) 16:1476-1480) serve as references. TEM images of reference CNTs and reference S @CNTs are presented in FIGS. 3A and 3B, respectively. TEM images of CNTs synthesized according to the procedure in Example 1 are presented in FIG. 3C. XRD and TEM images of phase-pure p-FeS₂ nanopowders are presented in FIG. 3D.

A comparison of FIGS. 3C and 3D to FIGS. 3A and 3B demonstrates that the synthesized CNTs showed comparable quality to the reference CNTs. The synthesized CNTs comprised a small amount of concomitant carbon clusters resulting from the PAN residual on the AAO surface that was not fully removed by an un-optimized oxygen plasma treatment. Results also confirmed that the NaOH etching solution did not attack FeS₂ (see FIG. 3C).

Synthesized CNTs are tested for both graphitic carbon and amorphous carbon, which the reference CNTs contain, using Raman spectroscopy.

p-FeS₂ @CNTs are characterized by XRD, TEM, FESEM (field emission scanning electron spectroscopy), EDX (energy dispersive X-ray absorption spectroscopy), and Raman.

### Example 3

### Electrochemical Measurements

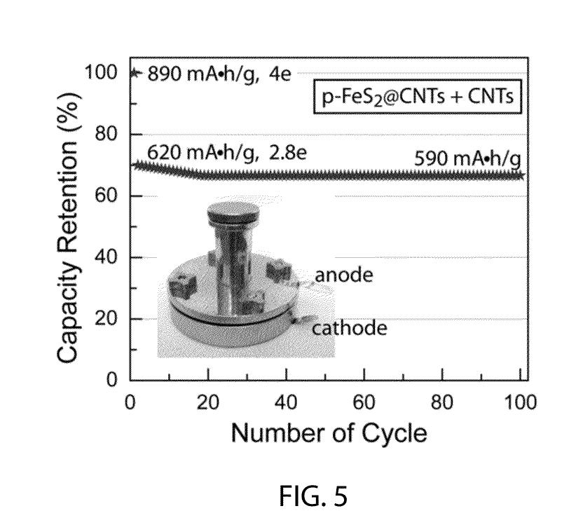

Electrochemical measurements are conducted using a two-electrode split-flat cell (MTI Corp., Richmond, Calif.) (see FIG. 5, inset). Electrode materials are pressed into a pellet together with aluminum foil as the current collector. The thickness of the pellet is about 10 μm, and the diameter is about 1.5 cm. The accurate mass of the active electrode material of p-FeS₂ is determined by measuring the gross mass of the electrode materials with an analytical balance and measuring the elemental compositions of Li, Fe, S, and C with EDX (except for Li) and ICP-AES (inductively charged plasma-atomic emission spectroscopy). The counter/reference electrode is a piece of lithium foil separated from the p-FeS₂ working electrode by a microporous membrane separator (Celgard 3501, Charlotte, N.C.). The electrolyte is 1 M LiTFSI (bis-(trifluoromethane)sulfonimide lithium salt) in TEGDME (tetra(ethylene glycol) dimethylether).

A conventional electrolyte solution of LiPF₆ in EC/DME (ethylene carbonate/dimethyl carbonate) degrades in the presence of redox products of p-FeS₂. However, a LiTFSI/TEGDME electrolyte solution shows superior capacity and cyclability compared to the LiPF₆/EC-DMC electrolyte.

To determine if capacity degradation is limited by the electrolyte solution rather than by the electrode, the cell is disassembled after 20 cycles and the cell components (electrolyte, separator, and lithium anode) are replaced with new ones while the electrode remains unchanged. The cyclability of charge capacity is tested according to the standard Galvanic charging/discharging experiments described in Takeuchi et al. (J. Electrochem. Soc. (2012) 159:A75-A84).

Using the cell of FIG. 5 (see inset), the typical charging/discharging rate is 0.5 C (i.e., 0.5 hour per cycle). The capacity during the initial discharging process is approximately 890 mA·h/g. The second discharging cycle is approximately 620 mA·h/g, which corresponds to an injection of 2.8Li⁺ per Fe into Li_{1.2}FeS₂, which is formed after the first charging process. Subsequently, the capacity-fading rate is <0.05% per cycle with a retention ratio of >67% after 100 cycles (590 mA·h/g) for the p-FeS₂@CNTs+CNTs composite cathode. (FIG. 5). The retention ratio is notably better than the 64% retention ratio after 15 cycles for the LiₓFeS₂ electrode described in Takeuchi et al (id.).

### Example 4

### Measurements of Specific Energy Density and Rate Capability

Voltage and charge capacity are measured with a potentiostat or battery analyzer, and mass of p-FeS₂ material is measured with a balance. Then specific energy density (E) is determined according to E=∫VdQ, where V is the voltage and Q is the charge capacity. A high rate capability is achieved in conjunction with a large charge capacity. Retention ratios are 67% at 0.5 C and 50% at 3 C.

### Example 5

### Measurements of Cyclic Voltammetry

Cyclic voltammetry (CV) provides information about at least the following electrochemical reactions:

FeS₂+2Li⁺+2e⁻→Li₂FeS₂ (1)

Li₂FeS₂+2Li⁺+2e⁻→Fe⁰+2Li₂S (2)

Fe⁰+2Li₂S→Li₂FeS₂+2Li⁺+2e⁻ (3)

Li₂FeS₂→Li₂₋ₓFeS₂+xLi⁺+xe⁻(0<x≦0.8). (4)

Potential is measured with a potentiostat or battery analyzer. The potential is scanned in the range of 0.9V (the end of discharging) to 2.0V (the end of charging to Li_{1.2}FeS₂) or 2.5V (the end of charging to Fe₁₋ₓS+S) at a scan rate of 1-10 mV/s.

### Example 6

### Determination of Chemical Identities of Discharging and Re-Charging Products

The chemical identities of the discharging and re-charging products are determined for p-FeS₂@CNTs. Because p-FeS₂ is not reproduced after the first discharging/charging cycle, the identities of the re-charging products are determined after the first cycle and after the retention ratio falls below 50%. The discharging products are usually Fe+Li₂S. The re-charging products depend on the applied voltages and vary from Li₂FeS₂ through Li₂₋ₓFeS₂ (0<x<0.8) to pyrrhotite Fe₁₋ₓS (0≦x≦0.2)+S.

Ex situ XRD, ex situ Raman, and ICP-AES are used to determine chemical identities. XRD detects crystalline materials, whereas Raman spectroscopy is sensitive to both crystalline and amorphous materials. Raman is employed when crystalline products are not present, or where crystal sizes are too small to be detected by XRD, such as when crystal sizes of charging/discharging products decrease with cycles.

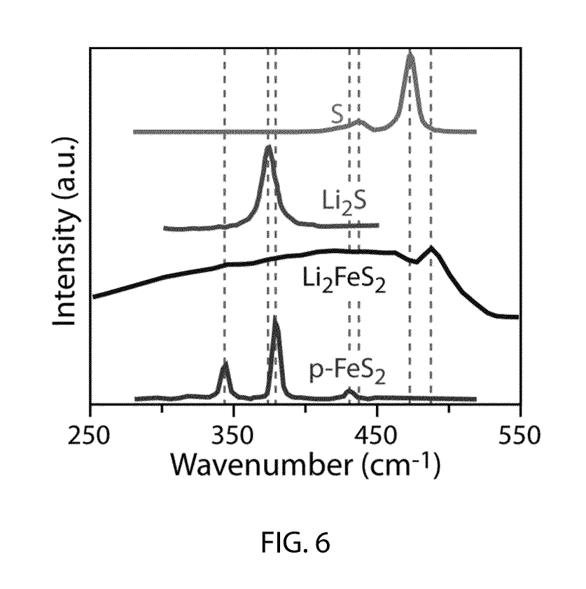

FIG. 6 displays the Raman spectra of p-FeS₂ nanoparticles (line labeled “p-FeS₂”), reference Li₂FeS₂ (line labeled “Li₂FeS₂”), reference Li₂S (line labeled “Li₂S”), and S (line labeled “S”; measured using commercial powder). The charging/discharging products are identified by comparing the obtained Raman spectra with the spectra in FIG. 6.

When the over-charged (>2.0V) products are Fe₁₋ₓS+S, S is detected by Raman. Fe₁₋ₓS is Raman inactive due to the cubic symmetry of its crystal structure. When Fe₁₋ₓS exists as amorphous compounds, its presence is deduced from the existence of sulfur rather than from XRD or Raman.

The quantity of lithium in a Li₂₋ₓFeS₂re-charging product is determined by ICP-AES. The p-FeS₂@CNTs electrode is washed three times with the solvent TEGDME before ICP-AES measurements. To eliminate the interference of the Li⁺ ions from the electrolyte residual that is un-removed by solvent washing, another p-FeS₂@CNTs electrode treated in the same way but without the charging/discharging treatment serves as the control.

### Example 7

### Measurement of Properties of FeS₂@ CNTs Electrodes and p-FeS₂ Electrodes

The electrical conductivity (a) of the discharging products is measured using a standard four-probe technique as described in Yang et al. (Nano Letters (2008) 8:2447-2451) and Yang et al. (ACS Nano (2009) 3:4144-4154). The electrical conductivity of CNT-containing electrodes is improved over p-FeS₂ electrodes.

The chemical species on the electrode surfaces after electrochemical treatments are identified using XPS as described in Zhu et al. (Carbon (2008) 46:1829-1840). Chemical species identification establishes whether irreversible chemical reactions (e.g., FeS₂+2Li⁺+2e⁻→Li₂FeS₂) have been prevented.

The amount of sulfur in the electrolyte solution after electrochemical treatments is quantified using ICP-AES as described in Yang et al. (JACS (2008) 130:15649-15661). Sulfur quantification helps determine the effectiveness of CNTs in preventing sulfur loss.

The electrical conductivity (a) of the re-charging products is measured using a standard four-probe technique as described in Yang et al. (Nano Letters (2008) 8:2447-2451) and Yang et al. (ACS Nano (2009) 3:4144-4154). Determining the electrical conductivity of the re-charging products helps to establish the efficacy of alleviating the loss of electrical contact that may be due to volume fluctuation.

TEM is used to determine any morphological deformation or damage of the CNTs.

Electrochemical impedance spectroscopy (EIS) is used to determine the electronic and ionic transport of the electrodes according to the methods described in Guo et al. (Electrochimica Acta (2011) 56:3981-3987), Zhu et al. (supra), and Zhuang et al. (Journal of Physical Chemistry C (2010) 114:8614-8621).

The diffusion coefficient of Li⁺ (D_{Li+}) is determined using potential step chronoamperometry, according to the Cottrell equation:

$$i = \frac{{FD}_{{Li}^{+}}^{1 / 2} {C}_{{Li}^{+}}^{*}}{{π}^{1 / 2} {t}^{1 / 2}} ,$$

where i is the current density, F is the Faraday constant, C*_{Li+} is the bulk concentration of the Li⁺, and t is the time. Determining the D_{Li+} provides insight into the lithium diffusivity inside CNTs because a large D_{Li+} may be critical for large charge capacity and high rate capability.

The above specification and examples provide a complete description of lithium ion battery cathode materials. Although various embodiments have been described above with a certain degree of particularity, or with reference to one or more individual embodiments, those skilled in the art could make numerous alterations to the disclosed embodiments without departing from the spirit or scope of this disclosure. Other embodiments are therefore contemplated. All matter contained in the above description is illustrative only of particular embodiments and not limiting. Changes in detail or structure may be made without departing from the basic elements described herein.

What is claimed is:

1. A lithium ion battery cathode material comprising:
a plurality of carbon nanostructures and iron pyrite.

2. The cathode material of claim 1, wherein the nanostructures are nanotubes.

3. The cathode material of claim 1, wherein at least a subgroup of the nanostructures encapsulate the iron pyrite.

4. The cathode material of claim 3, wherein the subgroup is configured to protect the iron pyrite from an electrolyte.

5. The cathode material of claim 3, wherein the subgroup has a diameter of 25-250 nm.

6. The cathode material of claim 3, wherein the subgroup has a diameter of 50-200 nm.

7. The cathode material of claim 3, wherein the nanostructures and subgroup are configured to form an electrical network.

8. The cathode material of claim 3, wherein the capacity-fading rate is <0.05% per cycle.

9. The cathode material of claim 3, wherein the retention ratio is >67% after 100 discharging/charging cycles.

10. A method of making carbon nanostructure-encapsulated iron pyrite comprising:
producing anodic aluminum oxide-encapsulated carbon nanostructures;
soaking anodic aluminum oxide-encapsulated carbon nanostructures in a solution of Fe(S₂CNEt₂)₃ to produce iron pyrite inside the carbon nanostructures; and
dissolving the anodic aluminum oxide.

11. The method of claim 10, further comprising collecting the carbon nanostructure-encapsulated iron pyrite.

12. The method of claim 10, wherein the nanostructures are nanotubes.

13. The method of claim 10, wherein the anodic aluminum oxide is a template for the nanostructures.

14. The method of claim 10, wherein the iron pyrite is produced inside the nanostructures via solvothermal decomposition of Fe(S₂CNEt₂)₃.

15. The method of claim 10, wherein performing the soaking step prior to the dissolving step produces iron pyrite only on the inside of the nano structures.

16. The method of claim 15, wherein the iron pyrite is protected from an electrolyte.
